(19) United States
(12) Patent Application Publication
(10) Pub. No.: US 2019/0322389 A1
(43) Pub. Date: Oct. 24, 2019

(54) Systems and Method for Automated Reconfiguration of Airplane Interiors

(71) Applicant: The Boeing Company, Chicago, IL (US)

(72) Inventors: Joseph F. Floyd, University Place, WA (US); Brent L. Hadley, Kent, WA (US); Patrick J. Eames, Newcastle, WA (US); Kyle M. Hadley, Kent, WA (US); Robert J. Martin, Seattle, WA (US); Christian J. Sarmiento, Kirkland, WA (US)

(73) Assignee: The Boeing Company, Chicago, IL (US)

(21) Appl. No.: 15/960,131

(22) Filed: Apr. 23, 2018

(51) Int. Cl. B64F 5/10; G06F 17/30; G06F 17/50

(52) U.S. Cl. CPC B64F 5/10; G06F 17/30876; G06F 3/04842; G06F 17/5095; G06F 17/30011

(57) ABSTRACT

Systems and methods for creating airplane interior modification packages and associated proposals. The method for creating modification packages comprises the following steps: (a) interacting with a user interface presented on a display screen to select a specific airplane type and a specific airplane of the specific airplane type, which specific airplane has an initial interior configuration; (b) interacting with the user interface to select parts to be removed from and parts to be added to the initial interior configuration of the specific airplane to create a modified interior configuration; (c) extracting change results data identifying parts selected for removal and parts selected for addition; (d) creating a modification package that includes drawings and documentation relevant to removing or adding the parts identified by the change results data; and (e) delivering the modification package to an authorized party associated with the specific airplane.

### BACKGROUND

The present disclosure relates generally to airplane and, in particular, to reconfiguring an airplane. Still more particularly, the present disclosure relates to methods and apparatus for modifying an airplane interior.

### SUMMARY

The subject matter disclosed in some detail below is directed to systems and methods for rapidly and inexpensively creating airplane interior modification packages with sufficient engineering and architectural detail, including cost information, for use in the creation of proposals (including the total cost of the proposed modifications). In particular, the system is configured to enable an airline to interactively modify airplanes to reconfigure their interiors based on options selected from airplane interior parts catalogs specific to each airplane type (an airplane model may include airplanes of multiple types). The system is further configured to enable the airplane modification service provider to create a complete modification package with drawings, documentation and renderings, if applicable, based on the features and options selected by the airline.

Although various embodiments of systems and methods for creating airplane interior modification packages and associated proposals including the total cost of the proposed modifications will be described in some detail below, one or more of those embodiments may be characterized by one or more of the following aspects.

One aspect of the subject matter disclosed in detail below is a method for modifying an airplane interior, comprising the following steps: (a) receiving first digital data representing a selection by a user interacting with a first graphical user interface of a specific airplane with an initial interior configuration; (b) receiving second digital data representing selections by a user interacting with a second graphical user interface of parts to be removed from and parts to be added to the initial interior configuration of the specific airplane to create a modified interior configuration; (c) extracting change results data identifying parts selected for removal and parts selected for addition from the second digital data; and (d) creating a modification package that includes documentation relevant to removing or adding the parts identified by the change results data.

Another aspect of the subject matter disclosed in detail below is a system for automated reconfiguration of an airplane interior, comprising a computer system comprising a processor, a network interface communicatively coupled to the processor, and a non-transitory tangible computer-readable storage medium communicatively coupled to the processor. The non-transitory tangible computer-readable storage medium contains a first database comprising digital data representing part numbers of parts incorporated in initial interior configurations of a multiplicity of airplanes and a second base comprising digital data representing identities of drawings and documents relevant to the initial interior configurations of the multiplicity of airplanes. The processor is configured with executable code for performing the following operations: (a) receiving first digital data representing user selections of a specific airplane type and a specific airplane of the specific airplane type by a user at a client station that is connected to the network interface via a network; (b) retrieving from the first database second digital data representing part numbers for parts included in the initial interior configuration; (c) receiving third digital data representing user selections of parts to be removed from and parts to be added to an initial interior configuration of the specific airplane; (d) retrieving from the first database fourth digital data representing part numbers for parts included in a modified interior configuration of the specific airplane derived by removing the selected parts from and adding the selected parts to the initial interior configuration; (e) extracting fifth digital data from the second digital data which has no matching digital data in the fourth digital data, the fifth data representing the part numbers of the parts to be removed; (f) extracting sixth digital data from the fourth digital data which has no matching digital data in the second digital data, the sixth data representing the part numbers of the parts to be added; (g) searching the second database for identities of drawings and documents relevant to the removal of the parts to be removed; (h) searching the second database for identities of drawings and documents relevant to the addition of the parts to be added; and (i) generating a human-readable report listing the identities of drawings and documents found in steps (g) and (h).

A further aspect of the subject matter disclosed in detail below is a method for determining a value of a parameter that varies as a function of a reconfiguration of an airplane interior, comprising: (a) interacting with a user interface presented on a display screen to select a specific airplane type and a specific airplane of the specific airplane type, which specific airplane has an initial interior configuration; (b) interacting with the user interface to select parts to be removed from and parts to be added to the initial interior configuration of the specific airplane to create a modified interior configuration; (c) retrieving from a database first data representing part numbers for parts included in the initial interior configuration; (d) retrieving from the database second data representing part numbers for parts included in the modified interior configuration; (e) comparing the first data to the second data to extract change results data identifying parts selected for removal and parts selected for addition; (f) electronically computing a value of a parameter associated with implementation of modifications embodying the modified interior configuration based in part on the change results data; (g) preparing a proposal that includes the computed parameter value; and (h) delivering the proposal to a recipient. The computed parameter value is one of the following: total cost or total labor hours of the reconfiguration or total weight of the specific airplane after reconfiguration.

Other aspects of systems and methods for creating airplane interior modification packages and associated proposals are disclosed below.

### BRIEF DESCRIPTION OF THE DRAWINGS

The features, functions and advantages discussed in the preceding section can be achieved independently in various embodiments or may be combined in yet other embodiments. Various embodiments will be hereinafter described with reference to drawings for the purpose of illustrating the above-described and other aspects. None of the diagrams briefly described in this section are drawn to scale.

FIG. 1 is a block diagram identifying components of a typical client system for enabling a user (e.g., a representative or an employee of an airline) to connect to a remote server via the Internet or other network for the purpose of interacting with an airplane interior configurator hosted by the remote server.

FIG. 2 is a block diagram representing a client system connected to an airplane modification server via the Internet in accordance with one embodiment.

FIG. 3 is a block diagram identifying components of a computer system suitable for use in the client system depicted in FIG. 1.

FIG. 4 is a flowchart identifying steps of a process for the production of an airplane interior modifications package by an airplane manufacturer or provider of modification services in response to electronic interactive reconfiguration of the interior of the airplane by an owner or operator.

FIG. 5 is a diagram representing an effectivity selector screenshot which enables a user to select a specific airplane by tail number for interior reconfiguration.

FIG. 6 is a diagram representing a screenshot showing an interactive layout of passenger accommodations for the specific airplane selected for interior reconfiguration.

FIG. 7 is a diagram representing the generation of a configuration differential list from initial and modified configuration parts trees.

FIG. 8 is a diagram representing a screenshot showing changes to the interior of the specific airplane made by the user.

FIG. 9 is a flow diagram of an airplane production and service methodology.

FIG. 10 is a block diagram showing systems of an airplane.

Reference will hereinafter be made to the drawings in which similar elements in different drawings bear the same reference numerals.

### DETAILED DESCRIPTION

The cabin interior arrangement, architectural details and the amenities that passengers experience on airplane flights influence their preference of airlines to travel with and can be a competitive advantage to airlines, and are therefore an important investment. Before modifying existing airplane interiors, airlines typically prefer to evaluate several different configuration options in order to compare esthetics, utility and costs. The relevant drawings and documentation supporting the proposed modification are typically included in a modification package that is sent to the airline by the entity that will provide the modification service. That modification package includes information that can be used to provide an estimate of total cost for inclusion in a proposal from the airplane modification service provider to the airline. For example, a modification package may include a statement of work

The creation of airplane modification packages is currently a very manual process of looking through data and drawings. The artifact is a large binder with the collection of drawings and documentation relevant to the actual modification or retrofit. It would be beneficial to make this process less time consuming, thereby increasing the availability of this process as a service to airlines. In addition, an improved process for creating modification packages would facilitate the development of proposals for interior reconfigurations with sufficient detail, including costs, for consideration by the airline. Such an improved process for creating modification packages may also have application in the modification of interiors of cruise ships.

Illustrative embodiments of systems and methods for creating airplane interior modification packages and associated proposals are described in some detail below. However, not all features of an actual implementation are described in this specification. A person skilled in the art will appreciate that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Airplanes that are purchased by customers may have different configurations. When a customer considers purchasing a particular model of an airplane, that model may have different versions from which the customer may select. After selecting a model and version of an airplane, the customer may also customize a particular version of the chosen airplane model. For example, when a customer selects a passenger version of an airplane, the customer also may pick various options for that version of the airplane. For example, the customer may pick options relating to galleys, lavatories, attendant seating, passenger seating, landing gear, engines, and other suitable options. Depending on the options selected, designs are generated for those customer-selected options.

With the selection of options, a design is generated for the customer-selected option. The design for the option is put through a process to certify the option as being airworthy. In other words, a process is followed to obtain a certification that the option meets regulations governing the airworthiness of the airplane. For example, the Federal Aviation Administration (FAA) propagates regulations for certifying the airworthiness of an airplane. These requirements include certifying designs for an airplane. These designs include those for customer-selected options.

Computing applications are available to help configuration engineers more accurately and efficiently configure the new airplanes purchased by operators (e.g., airlines). Called a “configurator”, this application reduces the complexity and time involved in defining the airplane configuration. The configurator application enables a rapid analysis of all operator-ordered changes to ensure technical compatibility and completeness. More specifically, the configurator application reduces the time required to select and validate options for the operator's configuration, replacing lengthy manual searches for information with real-time, online searches. It also provides the most accurate and current data available, including up-to-date prices and weights, which should help ensure the accuracy of data used throughout airplane production.

Finding options to meet an operator's business requirement often meant the airplane configuration engineer would have to manually search catalogs or other documents, or consult with another engineer to request further investigation. The configurator application makes this information more readily available to the operator, providing the opportunity to make faster, better informed decisions. The configurator application does this through a library of available options that can be searched easily and quickly using many different criteria. These criteria include specific part numbers, key words that might appear in the option title, and even part descriptions. The airplane configuration engineer can easily record airplane-specific configuration data into the operator's file during the configuration discussion. Using telecommunication capabilities and real-time data entry during the configuration discussion, an operator's encrypted configuration data will be able to be sent back quickly for entry into the pricing and offerability process. The result is a much faster turnaround time for a proposal to the operator.

There is a significant differentiation between completing a configuration for a new airplane and a modification of an existing airplane. A modification for an existing airplane is constrained by the same engineering rules that constrained the configuration of the new airplane, in addition to rules driven by pre-existing designs. Developing a configuration for a modification of an existing plane is constrained by design decisions made when the airplane is first configured as well as other preceding modifications made to the airplane. A modified airplane is constrained by the current configuration and the implications of that design in addition to the standard design constraints.

For example, a new airplane may be constrained such that the configuration of an aft lavatory is constrained by the spatial dimensions of the interior fuselage. On a modified airplane, in addition to being spatially constrained by the dimensions of the interior fuselage, the installation of an aft lavatory may also be constrained by the addition of an adjacent aft galley and existing electrical and water interfaces.

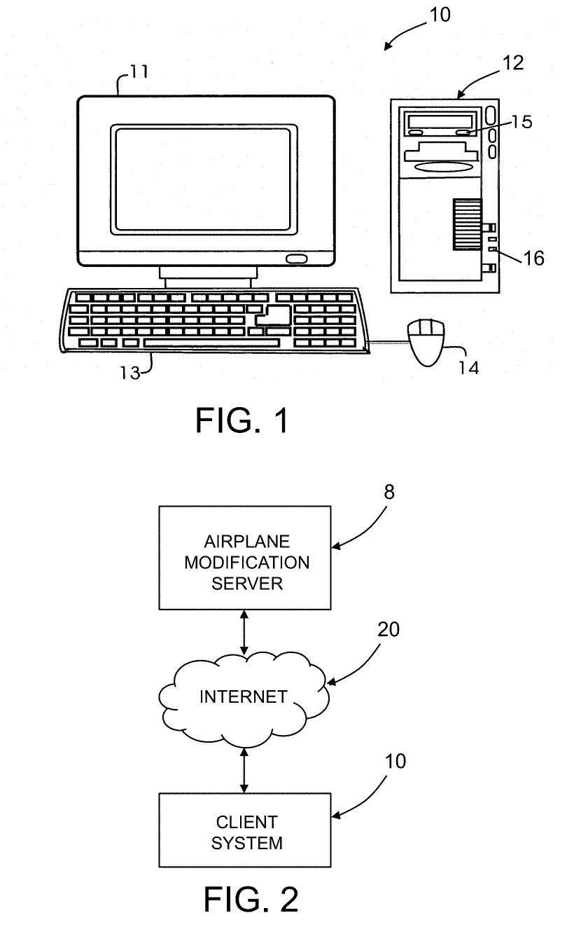

FIG. 1 is a block diagram identifying components of a typical client system for enabling a user (e.g., a representative or an employee of an airline) to connect to a remote server via the Internet or other network for the purpose of interacting with an airplane interior configurator hosted by the remote server. More specifically, the client system 10 includes a computer system 12 configured for executing computer-executable steps of an electronic airplane interior reconfiguration process. The client system 10 further includes a display monitor 11. Monitor 11 may be a cathode ray tube type, a liquid crystal display type, or any other type of color or monochrome display (or any other display device including a high-definition television station. The client system 10 is further provided with a keyboard 13 for entering data and user commands, and a pointing device 14 (for example, a mouse) for processing objects displayed on display monitor 11. The client system 10 further comprises a non-transitory tangible computer-readable storage medium device 15 for storing digital data. Besides other programs, non-transitory tangible computer-readable storage medium device 15 can store application programs, including web browsers by which computer system 12 is able to connect to the Internet (or any other network), and the computer-executable code that enables the airplane interior reconfiguration process disclosed herein. A CD-ROM interface (not shown) may also be provided to access application program files and data files stored on a CD-ROM. The computer system 12 is configured with web browser software to connect to the Internet. An integrated services digital network connection or the like also provides computer system 12 with an Internet connection 16 to the World Wide Web. The Internet connection 16 allows the computer system 12 to download data files, application program files and computer-executable code embodying at least some of the airplane interior reconfiguration process steps disclosed herein. In the alternative, the client system 10 may comprise a notebook or laptop computer, a smart phone, a personal digital assistant, etc.

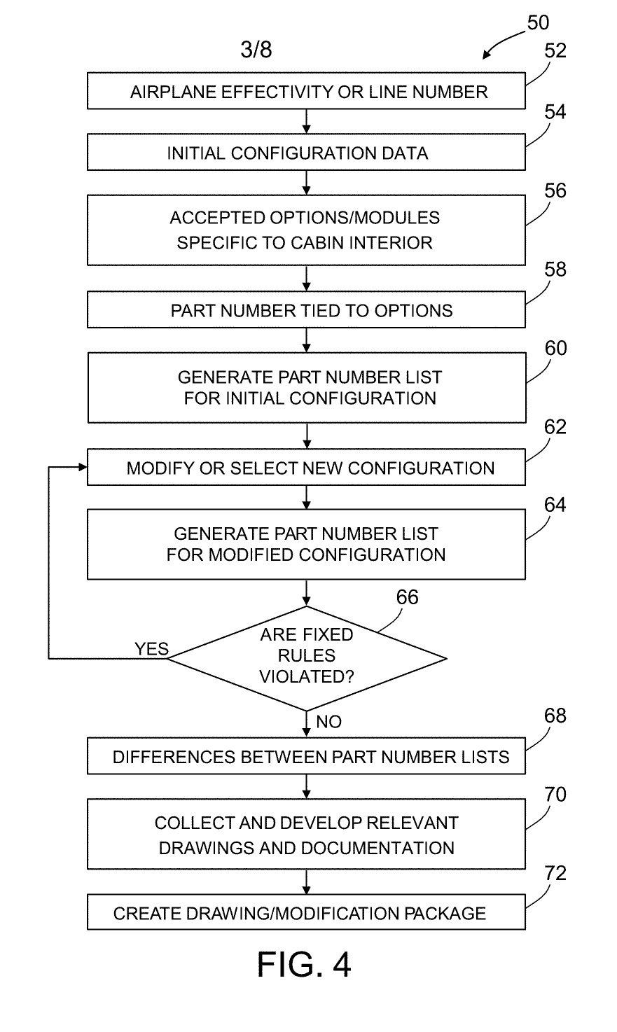

FIG. 2 is a block diagram representing a client system 10 connected to an airplane interior reconfiguration server 8 via the Internet 20 in accordance with one embodiment. In response to a request for airplane interior reconfiguration service from the client system 10, the airplane interior reconfiguration server 8 sends a web page to the client system which is displayed on the display monitor 11. By interacting with the downloaded web page, the user of the client system 10 may initiate the reconfiguration process by first selecting a specific airplane to be modified, which selection is sent to the airplane modification server 8. This step and additional steps (such as requesting a video tour of the airplane interior, requesting a three-dimensional model visualization of the airplane interior, removing parts from the configuration of the airplane interior and adding parts to the configuration of the airplane interior) will be described in more detail below with reference to FIG. 4.

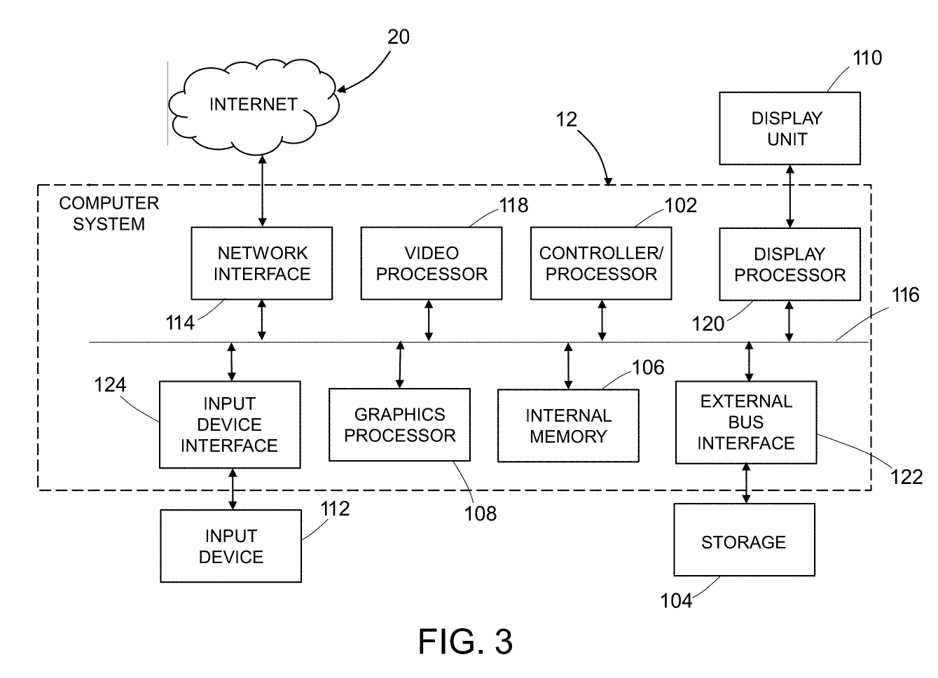

FIG. 3 is a block diagram identifying components of a generic computer system suitable for use in the client system 10 depicted in FIG. 1. The computer system 100 includes various processing, interface and memory units such as, for example, a processor 102, an internal memory 106, a graphics processor 108, a network interface 114, a video processor 118, a display processor 120, an external bus interface 122, and an input device interface 124, all of which are connected to and can communicate via a data bus 116. The processor 102 may direct the operation of the various processing and interface units within computer system 100.

The computer system 100 comprises a network interface 114 for transmitting and/or receiving information from a remote server station (not shown in FIG. 2) via a network. In the example shown in FIG. 2, the network interface 114 is shown communicatively coupled to the Internet 20. Thus the user of the client system depicted in FIG. 1 can retrieve data from and send data to a remote airplane modification server (not shown in FIG. 2) via network interface 114. The network interface 114 may be configured to transmit and/or receive information by physical (wired) and/or wireless communications links. Examples of suitable communication interfaces include a network interface controller (wired or wireless) or the like.

The display processor 120 processes data received via the network interface 114 to facilitate the display of that data on a display unit 110. The display unit 110 may be configured to present or otherwise display information to a user. Suitable examples include a liquid crystal display, light-emitting diode display, plasma display panel or the like. The displayed data may include a layout of passenger accommodations (LOPA) for an airplane, three-dimensional (3-D) model visualizations of the interior of an airplane or video tours of the of the interior of an airplane, depending on what data the user of the client system 10 has requested from the remote airplane modification server.

If the user has requested a 3-D model visualization of one or more parts of an airplane interior, the graphics processor 108 processes the received 3-D model data and sends the processed data to the display processor 120 for display. If the user has requested a video tour of the interior of an airplane, the video processor 118 processes the received video image data and sends the processed data to the display processor 120 for display. The various processors identified in FIG. 3 may be implemented with one or more digital signal processors, microprocessors, etc.

A processor is generally any piece of computer hardware that is capable of executing computer programs that process data (e.g., a 3-D model visualization application). A processor may comprise electronic circuits, some of which may be packaged as an integrated circuit (e.g., a chip) or multiple interconnected integrated circuits. Each processor may be configured to execute computer programs, which may be stored onboard the processor or otherwise stored in a memory as computer-readable program code. In alternative embodiments, the processor may be embodied as or otherwise include one or more application-specific integrated circuits, field-programmable gate arrays or the like.

Still referring to FIG. 3, the internal memory 106 stores data and/or instructions for various units within the computer system 100. The external bus interface 122 facilitates transfer of data between the computer system 100 (e.g., internal memory 106) and a storage unit 104. The internal memory 106 and the storage unit 104 are respective non-transitory tangible computer-readable storage media. The storage unit 104 is generally any piece of hardware that is capable of storing digital data and computer programs (e.g., computer-readable program code and database files) on a permanent basis. Such storage may take the form of a hard drive, a solid-state drive, a USB flash drive, an optical disk, a magnetic tape or some combination thereof. The internal memory 106 is generally any piece of computer hardware that is capable of storing digital data and computer programs (e.g., computer-readable program code and database files) on a temporary basis. The internal memory 106 may include volatile and non-volatile memory, and may be fixed or removable. Examples of suitable memory include random access memory, read-only memory, a hard drive, a flash memory, a thumb drive, an SD card, an optical disk, or some combination thereof. In various instances, the storage unit 104 and the internal memory 106 may be referred to as a non-transitory tangible computer-readable storage medium. A non-transitory tangible computer-readable storage medium is a non-transitory device capable of storing information, and is distinguishable from computer-readable transmission media such as electronic transitory signals capable of carrying information from one location to another.

The computer system 100 further comprises an input device interface 124 that is configured to convert signals generated by an input device 112 in response to inputs by a user into electrical signals. The input device 112 may be wired or wireless, and may be configured to receive information from a user into the client system 10, such as for processing, storage and/or display. Examples of suitable user input devices include a mouse, microphone, image or video capture device, keyboard or keypad, joystick, touch-sensitive surface (separate from or integrated into a touchscreen), biometric sensor or the like.

In particular, the computer system 100 is configured to perform functions that enable a user to interact with the airplane interior reconfiguration server 8 via the Internet 20 or some other network for the purpose of reconfiguring the interior of a specific airplane. The airplane interior reconfiguration server 8 (see FIG. 2) may have the same computer architecture as is depicted in FIG. 3. In that event, the storage unit 104 serves as the repository for various databases, such as an airplane interior parts database (storing data representing all of the parts comprising the interior of each airplane of a multiplicity of airplane identified by tail number), an airplane interior parts catalog (storing data representing parts available for purchase during an interior reconfiguration), a video image database (storing video tours of airplane interiors) and a 3-D model database (e.g., storing 3-D CAD model data for all or many parts and assemblies of parts making up the interiors of the airplanes having data in the database).

Referring again to FIG. 2, a representative of an airline may utilize the client system 10 to connect to and interact with the airplane interior reconfiguration server 8 via the Internet or connect to and interact with an airplane modification server that is accessible via some other wide-area network or a local area network. The airplane modification server may comprise a computer system capable of accessing various databases storing digital data representing structural features, components and parts of a multiplicity of airplanes, each airplane being identifiable by a tail number (a.k.a. registration number). All civil airplane are registered with a national aviation authority using procedures set by each country. The national aviation authority allocates a unique alphanumeric string to identify the airplane.

FIG. 4 is a flowchart identifying steps of a process 50 for the production of an airplane interior modification package by an airplane manufacturer or provider of modification services in response to electronic interactive reconfiguration of the interior of an airplane by an employee or representative of the owner or operator of that airplane using the system depicted in FIG. 2.

In the first step of the process, the user enters the web address or key words identifying the airplane interior reconfiguration server 8 into a URL or search field produced by a web browser on the client system 10. In response to receipt of a request for service from the client system 10, the airplane interior reconfiguration server 8 downloads a user authentication web page to the client system. The user inputs a customer name and password, as result of which another web page is downloaded that presents the user with various selectable options identified by clickable fields labeled “Models”, “Scenarios”, Catalog” and “Help” on the toolbar. The “Models” web page is also displayed. This web page has fields for enabling the user to select an airplane model (e.g., the 737 NG) by entering an airplane model identifier in a field.

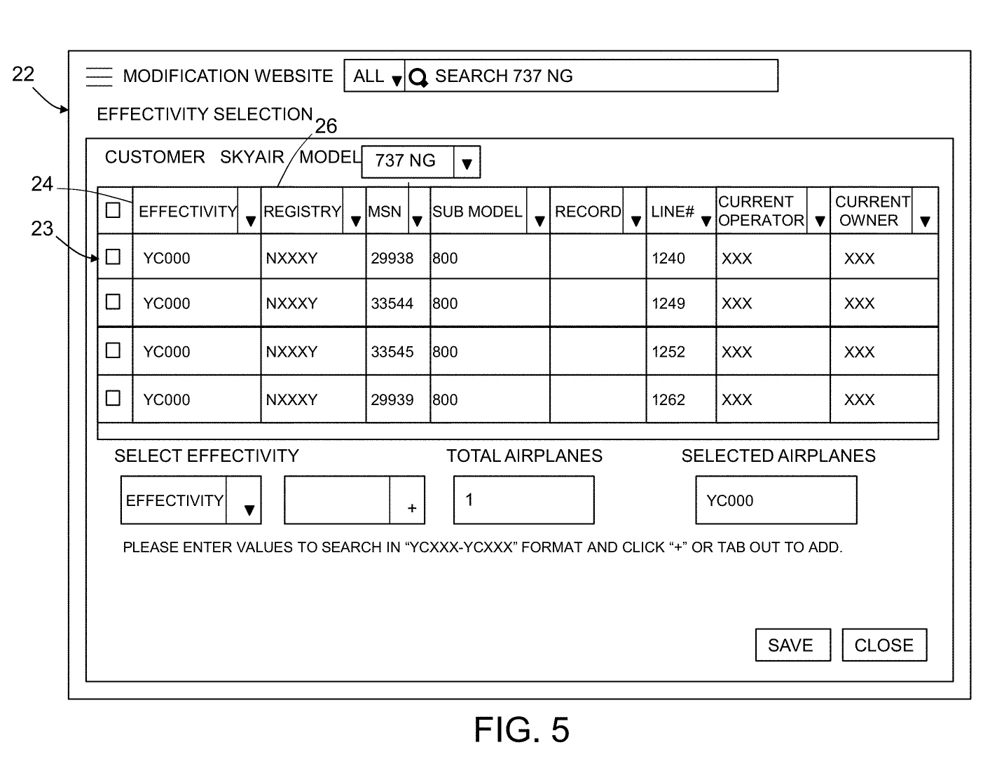

In response to the user selecting a particular airplane model, an “Effectivity Selection” web page corresponding to that particular airplane model is downloaded from the airplane modification server 8. Methods for defining and managing the relationship of variants to a product family exist. One such method is termed the “effectivity method”. Traditional effectivity defines which parts go into each end product configuration. In the present context, the effectivity is an alphanumeric identifier that identifies an airplane type (an airplane model may include airplanes of multiple types) that includes airplanes of a particular model that have some common interior parts. FIG. 5 is a diagram representing a screenshot of one example of an “Effectivity Selection” user interface 22. The user interacts with the “Effectivity Selection” user interface presented on the display screen to select a specific airplane type and a specific airplane of the specific airplane type, which specific airplane has an initial interior configuration (step 52 in FIG. 4). The “Effectivity Selection” user interface 22 includes an airplane table 23 that lists all airplanes of the particular model which are owned by the identified customer. As seen in this example, the airplane table 23 has a first column 24 with the heading “Effectivity”, which identifies the airplane type to which the specific airplane to be modified belongs, and a second column 26 with the heading “Registry”, which identifies the specific airplane by its registration number. Thus each row in the table corresponds to a different airplane having its own unique registration number. The user is able to scroll down the listed entries or enter a search term to find and then select the registration number of the specific airplane whose interior is going to be reconfigured (step 52 in FIG. 4).

Following the selection of the specific airplane whose interior is to be reconfigured, the user may click on the aforementioned “Scenarios” field, in response to which a drop-down list appears. That drop-down list identifies various scenarios that the user can select, including a scenario “Reconfigure my interior”. In response to the user selecting the “Reconfigure my interior” option, the airplane interior reconfiguration server 8 retrieves the previous configuration data (hereinafter “initial interior configuration data”) for that specific airplane from a database and then sends the initial interior configuration data to the client system 10 (step 54 in FIG. 4).

The airplane interior reconfiguration server 8 is further configured to determine which options/modules specific to the cabin interior being reconfigured were previously accepted (step 56 in FIG. 4). As used here, the term “module” refers to pre-certified engineering options which meet a group of regulations pertaining to airworthiness of an airplane. For example, after selecting a model and version of an airplane, the customer also may customize a particular version of the chosen airplane model. For example, when a customer selects a passenger version of an airplane, the customer also may pick various options for that version of the airplane. For example, the customer may pick options relating to galleys, lavatories, attendant seating, passenger seating, landing gear, engines, and other suitable options. Depending on the options selected, designs are generated for those customer-selected options. For example, with a lavatory, a customer may have the option to select how many lavatories are present in the airplane, the locations of the lavatories, and different features for the lavatories. Features that the customer may select include, for example, without limitation, a color, a texture, a soap dispenser system, a baby care table, and other features for the lavatory. With the selection of options, a design is generated for the customer-selected option. The design for the option is put through a process to certify the option as being airworthy. In other words, a process is followed to obtain a certification that the option meets regulations governing the airworthiness of the airplane. For example, the Federal Aviation Administration propagates regulations for certifying the airworthiness of an airplane. These requirements include certifying designs for an airplane. These designs include those for customer-selected options. Typically when a selected option for the airplane is received, a number of engineering options are considered to be prerequisites for installation of the selected option. For example, if a particular lavatory is selected by a customer that requires reinforcement of the floor to support the weight of the lavatory, that engineering option is presented to the customer as a module which can be accepted. Thus in step 56 of process 50, the airplane interior reconfiguration server 8 determines which modules were accepted during the original selection of parts for the cabin interior of the specific airplane.

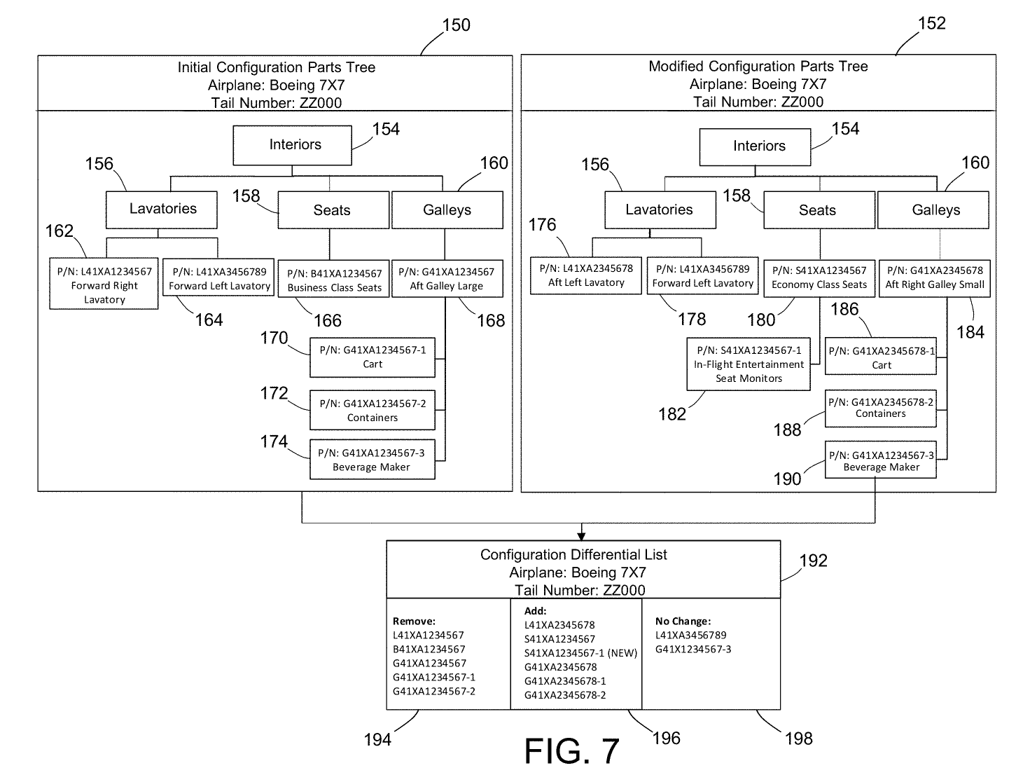

The airplane interior reconfiguration server 8 is further configured to then retrieve from a database the part numbers for all parts tied to the options originally selected by the customer (step 58 in FIG. 4). A part can be defined by a part number and its form, fit and function. Form, fit and function may include, but is not limited to, material type, surface finish, maintenance process, associated tooling, installation process, volume, part supplier, certification criteria, and color. The stored part numbers may be organized in and interrelated by a tree data structure. A typical tree data structure simulates a hierarchical tree structure with a root value and subtrees of children with a parent node, represented as a set of linked nodes. In other words, a tree that is not empty typically consists of a root node and multiple levels of additional nodes that form a hierarchy. (Examples of trees will be described below with reference to FIG. 7.) The retrieved part numbers identify all of the parts making up the initial interior configuration of the specific airplane. A list of part numbers identifying the parts included in the initial interior configuration (hereinafter “the initial interior configuration parts list”) is then generated and stored by the airplane interior reconfiguration server 8 for later use (step 60 in FIG. 4).

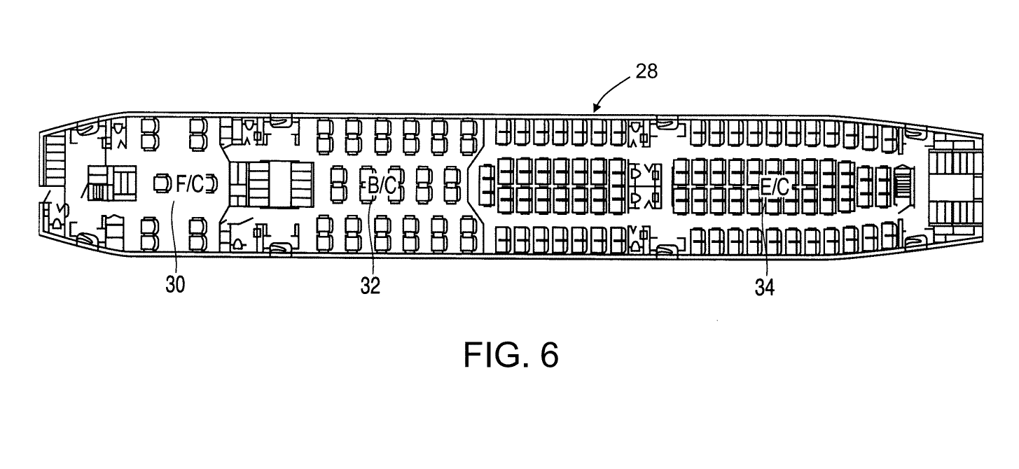

Returning attention to the user at the client system 10, the initial interior configuration data presented on the display screen 11 may take the form of an interactive Layout of Passenger Accommodations (LOPA). A representative interactive LOPA zone 28 is depicted in FIG. 6. The interactive LOPA zone 28 represents the entire passenger section of the airplane bounded by the forward and aft bulkheads. The interactive LOPA zone 28 can be divided into one or more seat class zones. Examples of seat class zones are First Class zone 30, Business Class zone 32, and Economy Class zone 34. Having a passenger airplane divided into seat class zones allows the configurator or other creators of rules to implement different rules in each seat class zone of the vehicle. Examples of rules that differ between seat class zones would be the width of the seats, the distance from the front to the back of the seat, the distance between the back of one seat to the front of another (e.g. the “legroom”), the amount by which the chairs are permitted to recline, and the width of aisles.

The user then interacts with the user interface to select parts to be removed from and added to the initial interior configuration of the specific airplane. The result of these deletions and additions will be referred to hereinafter as the “modified interior configuration” and the digital data representing the numbers of the parts that are included in the modified interior configuration will be referred to hereinafter as “modified interior configuration data”.

Presented with the interactive LOPA zone 28, the user can begin the process of reconfiguring the interior of the specific airplane (step 62 in FIG. 4). More specifically, the user may interact with the interactive LOPA zone 28 by clicking on interior components to be removed. Thereafter the user is able to add interior components by clicking on the aforementioned field named “Catalog”, in response to which the airplane interior reconfiguration server 8 sends a catalog which is displayed on the display screen of the client system 10. The catalog identifies all interior parts which are available for purchase by the customer for the airplane type of the specific airplane. By navigating through the catalog in a well-known manner, the user is able to select parts to be added to the interior configuration of the specific airplane. Returning to FIG. 4, the airplane interior reconfiguration server 8 is further configured to retrieve from a database the part numbers for all parts that are currently included in the modified interior configuration. The stored part numbers may be organized in and interrelated by a tree structure. The retrieved part numbers identify all of the parts making up the modified interior configuration of the specific airplane. A list of part numbers identifying the parts included in the modified interior configuration (hereinafter “the modified interior configuration parts list”) is then generated and stored by the airplane interior reconfiguration server 8 for subsequent use (step 64 in FIG. 4).

Interior design for configurable spaces, including passenger vehicles such as airplanes, requires adherence to numerous standards and rules. For example, in the United States, the Federal Aviation Administration imposes restrictions on commercial airliners regarding the number of doors, distance between doors and seats or other landmarks, and width of aisles. The airplane interior reconfiguration server 8 has access to a database that stores digital data representing fixed design constraint rules that are applicable to the specific airplane. These fixed design constraint rules include governmental rules, industry standards, manufacturer standards, and constraints based on the specific airplane model, or based on any specific monument to be placed within the specific airplane. In other words, the configurator hosted by the airplane interior reconfiguration server 8 is able to enforce the fixed design constraint rules when the user submits a modified interior configuration for a specific airplane.

In particular, the airplane interior reconfiguration server 8 is configured to determine whether any of the fixed design constraint rules are violated by the modified interior configuration (step 66 in FIG. 4). On the one hand, if the fixed design constraint rules are violated, the airplane interior reconfiguration server 8 generates feedback in the form of a message that appears on the display monitor 11 of the client system 10, informing the user that the modified interior configuration is rejected, advising which fixed design constraint rule was violated and inviting the user to resume the reconfiguration process to resolve the issue. If the user elects to resume the reconfiguration process, the process 50 depicted in FIG. 4 returns to step 62. On the other hand, if the fixed design constraint rules are not violated by the modified interior configuration, the airplane interior reconfiguration server 8 extracts change results data identifying interior parts selected for removal and interior parts selected for addition (step 68 in FIG. 4). More specifically, the change results data represents the differences derived from comparing data representing a first part numbers list (corresponding to the initial interior configuration) with data representing a second part numbers list (corresponding to the modified interior configuration).

FIG. 7 is a diagram representing the generation of a configuration differential list 192 from an initial configuration parts tree 150 and a modified configuration parts tree 152 for a fictional model “Boeing 7X7” airplane having a Tail Number ZZ000. The initial configuration of the interior of the airplane having Tail Number ZZ000 includes many parts, only a few of which are identified in the initial configuration parts tree 150 seen in FIG. 7. During the exemplary airplane interior reconfiguration process summarized in FIG. 7. some of those interior parts are removed and other interior parts are added, the result being a modified configuration of the airplane interior. The modified configuration of the airplane interior also includes many parts, only a few of which are identified in the modified configuration parts tree 152 seen in FIG. 7. The removed interior parts and a few representative unchanged parts appear in the initial configuration parts tree 150, whereas the added interior parts and the few representative unchanged parts appear in the modified configuration parts tree 152.

The initial configuration parts tree 150 and the modified configuration parts tree 150 each include a root node 154 identifying a parts category named “Interiors”, a child node 156 identifying a parts subcategory named “Lavatories”, a child node 158 identifying a parts subcategory named “Seats”, and a child node 160 identifying a parts subcategory named “Galleys”.

The initial configuration of the airplane interior as represented by the initial configuration parts tree 150 includes the following lavatories: a forward right lavatory identified by Part Number L41XA1234567 in a child node 162 and a forward left lavatory identified by Part Number L41XA3456789 in a child node 164. Both child nodes 162 and 164 are children of child node 156. The initial configuration of the airplane interior as represented by the initial configuration parts tree 150 further includes business class seats identified by Part Number B41XA1234567 in a child node 166 which is a child of child node 158. The initial configuration of the airplane interior as represented by the initial configuration parts tree 150 also includes a large aft gallery identified by Part Number G41XA1234567 in a child node 168 which is a child of child node 160. The large aft gallery in turn includes the following parts: a cart identified by Part Number G41XA1234567-1 in a child node 170, containers identified by Part Number G41XA1234567-2 in a child node 172, and a beverage maker identified by Part Number G41XA1234567-3 in a child node 174. All of child nodes 170, 172 and 174 are children of child node 168.

Similarly, the modified configuration of the airplane interior as represented by the modified configuration parts tree 152 includes the following lavatories: an aft left lavatory identified by Part Number L41XA2345678 in a child node 176 and a forward left lavatory identified by Part Number L41XA3456789 in a child node 178. Both child nodes 176 and 178 are children of child node 156. The modified configuration of the airplane interior as represented by the modified configuration parts tree 152 further includes economy class seats identified by Part Number S41XA1234567 in a child node 180 which is a child of child node 158. The economy class seats are equipped with in-flight entertainment seat monitors identified by Part Number S41XA1234567-1 in a child node 182 which is a child of child node 180. The modified configuration of the airplane interior as represented by the modified configuration parts tree 152 also includes a small aft right gallery identified by Part Number G41XA1234567 in a child node 168 which is a child of child node 160. The large aft gallery in turn includes the following parts: a cart identified by Part Number G41XA1234567-1 in a child node 170, containers identified by Part Number G41XA1234567-2 in a child node 172, and a beverage maker identified by Part Number G41XA1234567-3 in a child node 174. All of child nodes 170, 172 and 174 are children of child node 168.

As previously mentioned, during the exemplary airplane interior reconfiguration process summarized in FIG. 7. some of the interior parts identified in the initial configuration parts tree 150 are removed and other interior parts identified in the modified configuration parts tree 152 are added. In accordance with one proposed implementation, a data table 192 representing a list of the differences between the parts included in the initial configuration of the airplane interior and the parts included in the modified configuration of the airplane interior (hereinafter “configuration differential list”) is populated with data identifying the removed parts, the added parts and the unchanged parts. More specifically, the data table 192 includes: (a) a removed parts list 194 listing the Part Numbers of parts removed from the initial configuration of the airplane interior; (b) an added parts list 196 listing the Part Numbers of parts added to the modified configuration of the airplane interior; and (c) an unchanged parts list 198 listing the Part Numbers of parts not removed from the initial configuration of the airplane interior. In the example depicted in FIG. 7, the parts having Part Numbers L41XA1234567, B41XA1234567, G41XA1234567, G41XA1234567-1 and G41XA1234567-2 are listed in removed parts list 194; the parts having Part Numbers L41XA2345678, S41XA1234567, S41XA1234567-1, G41XA234568, G41XA2345678-1 and G41XA2345678-2 are listed in added parts list 196; and the parts having Part Numbers L41XA3456789 and G41XA1234567-3 are listed in unchanged parts list 198.

The airplane interior reconfiguration server 8 (see FIG. 2) is configured to retrieve from a database the part numbers for all parts that are currently included in the initial configuration of the airplane interior, receive the part numbers identifying the parts selectively removed and added by a remote user, populate the data table 192 with the Part Numbers listed in FIG. 7 to generate the configuration differential list based on the additions and subtractions made by the remote user, and send the populated data table to a non-transitory tangible computer-readable storage medium for storage for later use, such as in creating a modification package or a proposal.

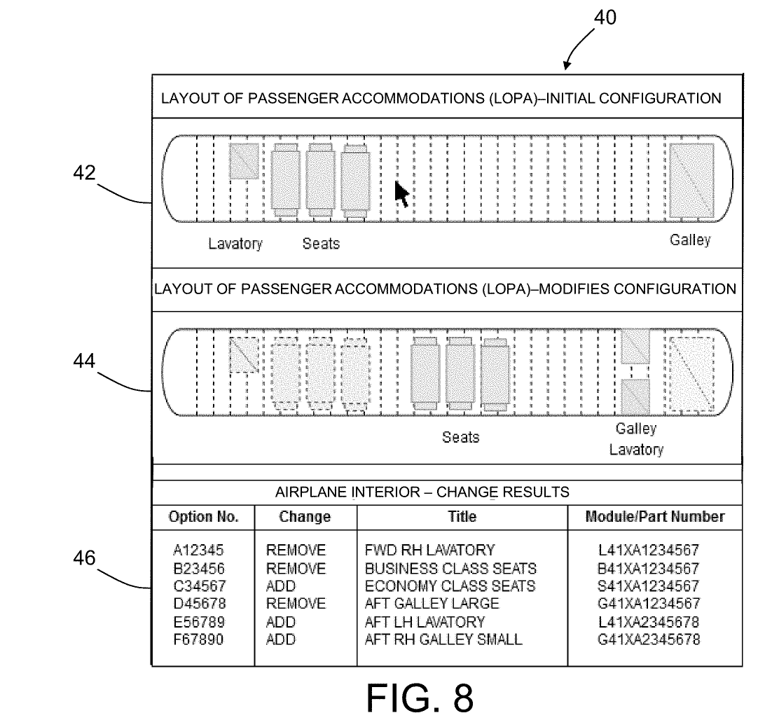

Following the extraction of the change results data, the airplane interior reconfiguration server 8 sends an .html file to the client system 10 containing instructions for the display of an airplane interior modifications page 40 (shown in FIG. 8) that shows the changes made by the user. More specifically, the airplane interior modifications page 40 includes: (1) a graphical display of an “Initial interior configuration” LOPA 42 having symbology representing the removed interior parts (the interior parts not removed are not depicted to avoid clutter in the drawing); (2) a graphical display of a “Modified interior configuration” LOPA 44 having symbology representing the added interior parts (again the unchanged interior parts are not shown); and (3) a change results table 46 that presents the change results data in a tabular format. The names and part numbers of the parts that have been removed or added are listed in the change results table 46, the information for the listed parts being presented in respective rows. The user may then save or print the airplane interior modifications page 40 before terminating the reconfiguration session.

The airplane interior reconfiguration server 8 is further configured to electronically search a drawings/documents database for the identities of all drawings and documents relevant to removing or adding the interior parts identified by the change results (step 70 in FIG. 4). In addition, other drawings and documents are developed manually to include new information reflecting the change results. All of the identified and developed drawings and documentation are printed. Then a modification package is manually created that includes the print-outs of the relevant drawings and documentation (step 72 in FIG. 4). For example, the modifications package may include a Bill of Materials, LOPA drawings, a Weight and Balance Manual, an Aircraft Flight Manual, Installation Instructions, Service Bulletins, etc. The modifications package is then delivered to the owner or operator of the specific airplane.

The airplane interior reconfiguration server 8 is further configured to electronically compute a total cost associated with implementing the modifications that embody the modified interior configuration, prepare a proposal that includes the total cost, and deliver the proposal (separate from or together with the modifications package) to the owner or operator of the specific airplane, which proposal the owner or operator may either accept or reject.

For the sake of illustration, it may be assumed the remote server system has the architecture depicted in FIG. 2. Under that assumption, the processor 102 is configured to perform the functions of the airplane modification server 8 depicted in FIG. 2, while storage unit 104 is the non-transitory tangible computer-readable storage medium referred to in the next paragraph.

In accordance with one embodiment, the system for automated reconfiguration of an airplane interior comprises the processor 102, the network interface 114 communicatively coupled to the processor 102, and a non-transitory tangible computer-readable storage medium (storage unit 104) communicatively coupled to the processor 102, wherein the non-transitory tangible computer-readable storage medium contains a first database comprising digital data representing part numbers of parts incorporated in initial interior configurations of a multiplicity of airplanes and a second base comprising digital data representing identities of drawings and documents relevant to the initial interior configurations of the multiplicity of airplanes. In addition, the processor is configured with executable code for performing the following operations: (a) receiving first digital data representing user selections of a specific airplane type and a specific airplane of the specific airplane type by a user at a client station that is connected to the network interface via a network; (b) retrieving from the first database second digital data representing part numbers for parts included in the initial interior configuration; (c) receiving third digital data representing user selections of parts to be removed from and parts to be added to an initial interior configuration of the specific airplane; (d) retrieving from the first database fourth digital data representing part numbers for parts included in a modified interior configuration of the specific airplane derived by removing the selected parts from and adding the selected parts to the initial interior configuration; (e) extracting fifth digital data from the second digital data which has no matching digital data in the fourth digital data, the fifth data representing the part numbers of the parts to be removed; (f) extracting sixth digital data from the fourth digital data which has no matching digital data in the second digital data, the sixth data representing the part numbers of the parts to be added; (g) searching the second database for identities of drawings and documents relevant to the removal of the parts to be removed; (h) searching the second database for identities of drawings and documents relevant to the addition of the parts to be added; and (i) generating a human-readable report listing the identities of drawings and documents found in steps (g) and (h). In this example, the fifth and sixth digital data can be combined to form the dataset which was previously referred to as “change results data”.

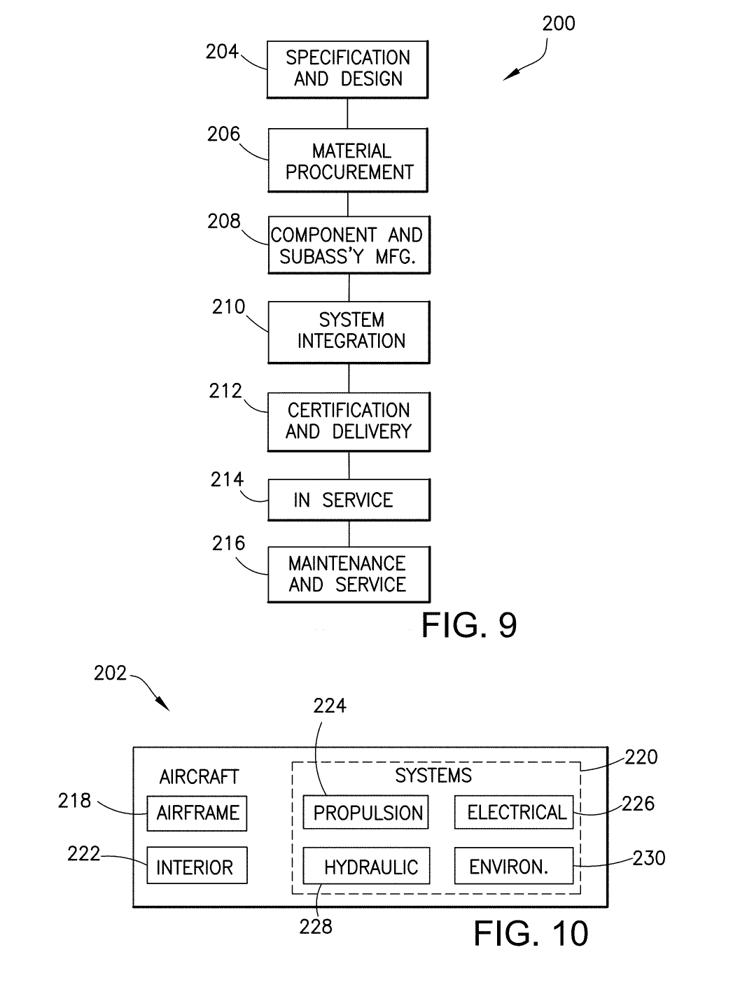

The system and method disclosed above may be employed in an airplane manufacturing and service method 200 as shown in FIG. 9 for reconfiguring the interiors of an airplane 202 as shown in FIG. 10. During pre-production, exemplary method 200 may include specification and design 204 of the airplane 202 and material procurement 206. During production, component and subassembly manufacturing 208 and system integration 210 of the airplane 202 takes place. Thereafter, the airplane 202 may go through and delivery 212 in order to be placed in service 214. While in service by a customer, the airplane 202 is scheduled for routine maintenance and service 216 (which may also include modification, reconfiguration, refurbishment, and so on).

Each of the processes of method 200 may be performed or carried out by a system integrator, a third party, and/or an operator (e.g., a customer). For the purposes of this description, a system integrator may include without limitation any number of airplane manufacturers and major-system subcontractors; a third party may include without limitation any number of venders, subcontractors, and suppliers; and an operator may be an airline, leasing company, military entity, service organization, and so on.

As shown in FIG. 9, the airplane 202 produced by exemplary method 200 may include an airframe 218 (comprising, e.g., a fuselage, frames, stiffeners, wing boxes, etc.) with a plurality of systems 220 and an interior 222. Examples of high-level systems 220 include one or more of the following: a propulsion system 224, an electrical system 226, a hydraulic system 228, and an environmental control system 230. Any number of other systems may be included. Although an aerospace example is shown, the principles disclosed herein may be applied to other industries, such as the shipbuilding industry.

Apparatus and methods embodied herein may be employed during one or more of the stages of the production and service method 200. One or more of apparatus embodiments, method embodiments, or a combination thereof may be utilized while the airplane 202 is in service, for example and without limitation, during maintenance and service 216. For example, an airplane interior may be reconfigured during routine maintenance and service 216 using the methodology disclosed herein.

While systems and methods for creating airplane interior modification packages with sufficient engineering and architectural detail, including cost information, have been described with reference to various embodiments, it will be understood by those skilled in the art that various changes may be made and equivalents may be substituted for elements thereof without departing from the scope of the teachings herein. In addition, many modifications may be made to adapt the teachings herein to a particular situation without departing from the scope thereof. Therefore it is intended that the claims not be limited to the particular embodiments disclosed herein.

The embodiments disclosed above use one or more computer systems. As used in the claims, the term “computer system” comprises a single processing or computing device or multiple processing or computing devices that communicate via wireline or wireless connections. Such processing or computing devices typically include one or more of the following: a processor, a controller, a central processing unit, a microcontroller, a reduced instruction set computer processor, an application-specific integrated circuit, a programmable logic circuit, a field-programmable gated array, a digital signal processor, and/or any other circuit or processing device capable of executing the functions described herein. The above examples are exemplary only, and thus are not intended to limit in any way the definition and/or meaning of the term “computer system”.

The methods described herein may be encoded as executable instructions embodied in a non-transitory tangible computer-readable storage medium, including, without limitation, a storage device and/or a memory device. Such instructions, when executed by a processing or computing system, cause the system device to perform at least a portion of the methods described herein.

The process claims set forth hereinafter should not be construed to require that the steps recited therein be performed in alphabetical order (any alphabetical ordering in the claims is used solely for the purpose of referencing previously recited steps) or in the order in which they are recited unless the claim language explicitly specifies or states conditions indicating a particular order in which some or all of those steps are performed. Nor should the process claims be construed to exclude any portions of two or more steps being performed concurrently or alternatingly unless the claim language explicitly states a condition that precludes such an interpretation.

1. A method for modifying an airplane interior, comprising:
(a) receiving first digital data representing a selection by a user interacting with a first graphical user interface of a specific airplane with an initial interior configuration;
(b) receiving second digital data representing selections by a user interacting with a second graphical user interface of parts to be removed from and parts to be added to the initial interior configuration of the specific airplane to create a modified interior configuration;
(c) extracting change results data identifying parts selected for removal and parts selected for addition from the second digital data; and
(d) creating a modification package that includes documentation relevant to removing or adding the parts identified by the change results data.

2. The method as recited in claim 1, further comprising:
formatting the change results data in tabular form; and
sending the change results data in tabular form for display on a remotely located computer being used by the user.

3. The method as recited in claim 1, further comprising:
retrieving from a database first data representing part numbers for parts included in the initial interior configuration; and
retrieving from the database second data representing part numbers for parts included in the modified interior configuration,
wherein step (c) comprises comparing the first data to the second data.

4. The method as recited in claim 1, wherein the second digital data is generated by interacting with a layout of passenger accommodations displayed on the second graphical user interface to select parts to be removed.

5. The method as recited in claim 1, wherein the second digital data is generated by interacting with a catalog displayed on the second user interface to select parts to be added.

6. The method as recited in claim 1, further comprising determining whether the modified interior configuration violates a fixed design constraint rule or not.

7. The method as recited in claim 6, further comprising generating a message that informing the user that the modified interior configuration violates the fixed design constraint rule.

8. The method as recited in claim 7, further comprising receiving additional second digital data representing selections by the user of other parts for removal or addition if the modified interior configuration violates the fixed design constraint rule.

9. The method as recited in claim 1, further comprising electronically searching a drawings and documents database for identities of all drawings and documents relevant to removing or adding the parts identified by the change results data.

10. The method as recited in claim 1, further comprising:
electronically computing a total cost associated with implementation of modifications embodying the modified interior configuration;
preparing a proposal that includes the total cost; and
sending the proposal to a recipient.

11. A system for automated reconfiguration of an airplane interior, comprising a computer system comprising a processor, a network interface communicatively coupled to the processor, and a non-transitory tangible computer-readable storage medium communicatively coupled to the processor, wherein the non-transitory tangible computer-readable storage medium contains a first database comprising digital data representing part numbers of parts incorporated in initial interior configurations of a multiplicity of airplanes and a second base comprising digital data representing identities of drawings and documents relevant to the initial interior configurations of the multiplicity of airplanes, wherein the processor is configured with executable code for performing the following operations:
(a) receiving first digital data representing user selections of a specific airplane type and a specific airplane of the specific airplane type by a user at a client station that is connected to the network interface via a network;
(b) retrieving from the first database second digital data representing part numbers for parts included in the initial interior configuration;
(c) receiving third digital data representing user selections of parts to be removed from and parts to be added to an initial interior configuration of the specific airplane;
(d) retrieving from the first database fourth digital data representing part numbers for parts included in a modified interior configuration of the specific airplane derived by removing the selected parts from and adding the selected parts to the initial interior configuration;
(e) extracting fifth digital data from the second digital data which has no matching digital data in the fourth digital data, the fifth data representing the part numbers of the parts to be removed;
(f) extracting sixth digital data from the fourth digital data which has no matching digital data in the second digital data, the sixth data representing the part numbers of the parts to be added;
(g) searching the second database for identities of drawings and documents relevant to the removal of the parts to be removed;
(h) searching the second database for identities of drawings and documents relevant to the addition of the parts to be added; and
(i) generating a human-readable report listing the identities of drawings and documents found in steps (g) and (h).

12. The system as recited in claim 11, wherein the processor is further configured with executable code for computing a total cost associated with implementation of modifications embodying the modified interior configuration.

13. A method for determining a value of a parameter that varies as a function of a reconfiguration of an airplane interior, comprising:
(a) interacting with a user interface presented on a display screen to select a specific airplane type and a specific airplane of the specific airplane type, which specific airplane has an initial interior configuration;
(b) interacting with the user interface to select parts to be removed from and parts to be added to the initial interior configuration of the specific airplane to create a modified interior configuration;
(c) retrieving from a database first data representing part numbers for parts included in the initial interior configuration;
(d) retrieving from the database second data representing part numbers for parts included in the modified interior configuration;
(e) comparing the first data to the second data to extract change results data identifying parts selected for removal and parts selected for addition;
(f) electronically computing a value of a parameter associated with implementation of modifications embodying the modified interior configuration based in part on the change results data;
(g) preparing a proposal that includes the computed parameter value; and
(h) delivering the proposal to a recipient.

14. The method as recited in claim 13, wherein the computed parameter value is one of the following: total cost or total labor hours of the reconfiguration or total weight of the specific airplane after reconfiguration.

15. The method as recited in claim 13, wherein step (b) comprises interacting with a layout of passenger accommodations displayed on the user interface to select parts to be removed.

16. The method as recited in claim 13, wherein step (b) comprises interacting with a catalog displayed on the user interface to select parts to be added.

17. The method as recited in claim 13, further comprising determining whether the modified interior configuration violates a fixed design constraint rule or not.

18. The method as recited in claim 17, wherein steps (a) and (b) are performed by a user, the method further comprising generating a message that appears on the user interface informing the user that the modified interior configuration violates the fixed design constraint rule.

19. The method as recited in claim 18, further comprising the user selecting other parts for removal or addition if the modified interior configuration violates the fixed design constraint rule.

20. The method as recited in claim 13, further comprising electronically searching a drawings/documents database for identities of all drawings and documents relevant to removing or adding the parts identified by the third data.

21. The method as recited in claim 20, further comprising:
creating a modification package that includes drawings and documentation relevant to removing or adding the parts identified by the change results data; and
delivering the modification package to a location.

22. The method as recited in claim 1, wherein the change results include structure, price, weight, electrical and plumbing changes.

23. The method as recited in claim 1, further comprising delivering the modification package to a location.
